(19) United States
(12) Patent Application Publication
(10) Pub. No.: US 2013/0163802 A1
(43) Pub. Date: Jun. 27, 2013

(54) MICROPHONE THAT IS WORN ON A PAIR OF EYEGLASSES

(71) Applicant: Liang-Chih CHENG, New Taipei City (TW)

(72) Inventor: Liang-Chih CHENG, New Taipei City (TW)

(21) Appl. No.: 13/337,710

(22) Filed: Dec. 27, 2011

(51) Int. Cl. H04R 1/02

(52) U.S. Cl. 381/364

(57) ABSTRACT

A microphone worn on a pair of eyeglasses includes a microphone body and at least a suspender. The microphone body includes a thin rod, an end of which is a high sensitivity microphone and the other end is a plug; the thin rod is assembled with an electric wire through the plug and a socket. An upper end of the suspender is installed on a temple at a side of the eyeglasses and a lower end is a hook unit. When the microphone body is used, the thin rod is installed on the hook unit to assemble the microphone body with the temple at the side of the eyeglasses; therefore, when the eyeglasses are worn, the microphone body is worn simultaneously. Not contacting with an ear to cause uncomfortableness, the microphone body is worn conveniently and handy, can be applied to frames of various sizes and carried conveniently.

### BACKGROUND OF THE INVENTION

a) Field of the Invention

The present invention relates to a microphone that is worn on a pair of eyeglasses, and more particularly to a microphone that is installed on a temple at a side of the eyeglasses, with that the microphone is worn conveniently and handy, does not contact with an ear to cause uncomfortableness, can be applied to frames of various sizes and carried conveniently.

b) Description of the Prior Art

As a microphone can be only used for one-way calling but not two-way dialoging, a headset microphone has been invented to increase convenience in dialoging, allowing people to talk to each other easily.

A conventional microphone that is hung on an ear, such as the Taiwanese new invention patent No. 094222117, “Behind-the-Ear Microphone,” is disclosed, wherein a microphone is provided at a front end of a thin rod, a small circular plate is sheathed into the microphone that is tightly attached to the thin rod, a rear end of the thin rod is formed with a hanging part and the hanging part is enclosed by a plastic tube.

The hanging part is provided with a longitudinal section and a hook section, an end of the longitudinal section corresponds to the hook section, and the thin rod is assembled with an electric wire through a plug and a socket; whereas, the other end of the electric wire is formed with a plug. By wearing the hanging part on a user's ear, the hook section of the hanging part will be abutted tightly at a rear side of an ear lobe and the longitudinal section of the hanging part will clip a front side of the ear lobe, allowing the hanging part to be stably worn on the ear, such that even when the user is doing any running or jumping action, the entire behind-the-ear microphone will not drop out of the ear.

Although being able to be stably worn on the ear, the conventional behind-the-ear microphone is worn on the ear by the hanging part and therefore, for the user who is wearing a pair of eyeglasses, a temple of the eyeglasses will be attached on the ear along with the hanging part, causing inconvenience in use and also allowing the user to feel uncomfortable, which is rather inconvenient. Accordingly, the abovementioned prior art is still provided with a lot of shortcomings and thus is not a good design that improvement is indeed required.

### SUMMARY OF THE INVENTION

The primary object of the present invention is to provide a microphone that is worn on a pair of eyeglasses, with that the microphone is installed on a temple at a side of the eyeglasses, is worn conveniently and handy, does not contact with the ear to cause uncomfortableness, can be applied to frames of various sizes and carried conveniently.

Another object of the present invention is to provide a microphone that is worn on a pair of eyeglasses, wherein the microphone is provided with a high sensitivity to absorb sound sources easily and can be applied to all kinds of wireless microphone transmitters and all kinds of wired amplifiers.

According to the abovementioned objects, the microphone that is worn on a pair of eyeglasses of the present invention includes a microphone body and at least a suspender, wherein the microphone body is provided with a thin rod, an end of the thin rod is provided with a high sensitivity microphone, the other end of the thin rod is provided with a plug, and the thin rod is assembled with an electric wire through the plug and a socket. An upper end of the suspender is installed on a temple at a side of the eyeglasses and a lower end of the suspender is provided with a hook unit; whereas, the thin rod of the microphone body can be installed on the hook unit of the suspender, allowing the microphone body to be assembled with the temple at the side of the eyeglasses, such that when the user is wearing the eyeglasses, he or she can wear the microphone body at a same time. When the microphone is to be used, the thin rod of the microphone body is installed on the hook unit of the suspender, allowing the microphone body to be assembled on the temple at the side of the eyeglasses. Therefore, when wearing the eyeglasses, the user can wear the microphone body at a same time, and the microphone body will not contact with the ear to cause uncomfortableness. Accordingly, the microphone can be worn conveniently and is handy, can be applied to frames of various sizes and carried conveniently.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of appearance of a microphone that is worn on a pair of eyeglasses, according to the present invention.

FIG. 2 shows a schematic view of use of the microphone that is worn on a pair of eyeglasses, according to the present invention.

### DETAILED DESCRIPTION OF THE PREFERRED EMBODIMENTS

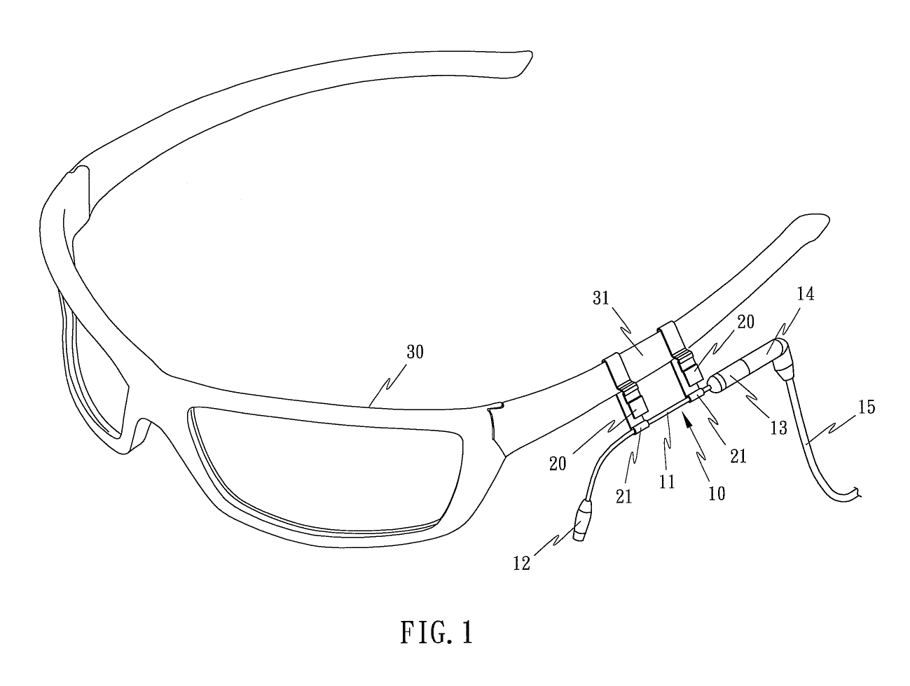

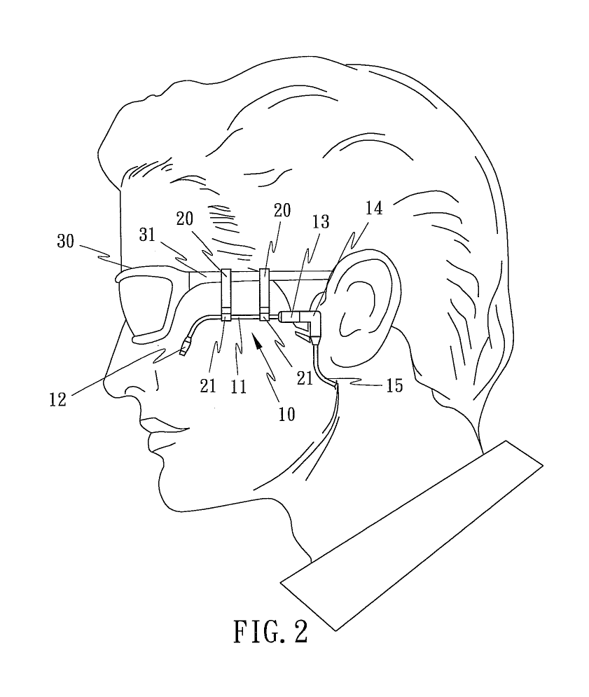

Referring to FIG. 1 and FIG. 2, the present invention discloses a microphone that is worn on a pair of eyeglasses, comprising primarily a microphone body 10 and at least a suspender 20.

The microphone body 10 is provided with a thin rod 11, an end of the thin rod 11 is provided with a high sensitivity microphone 12 and the other end of the thin rod 11 is provided with a plug 13; the thin rod 11 is assembled with an electric wire 15 through the plug 13 and a socket 14.

An upper end of the suspender 20 is installed on a temple 31 at a side of a pair of eyeglasses 30, and a lower end of the suspender 20 is provided with a hook unit 21; the thin rod 11 of the microphone body 10 can be installed on the hook unit 21 of the suspender 20, allowing the microphone body 10 to be assembled with the temple 31 at the side of the eyeglasses 30, such that when a user is wearing the eyeglasses 30, he or she can wear the microphone body 10 at a same time.

As shown in FIG. 2, when the microphone is to be used, the thin rod 11 of the microphone body 10 is installed on the hook unit 21 of the suspender 20, allowing the microphone body 10 to be assembled on the temple 31 at the side of the eyeglasses 30. Therefore, when the user is wearing the eyeglasses 30, he or she can wear the microphone body 10 at a same time, and the microphone body 10 will not contact with the ear to cause uncomfortableness, thereby achieving the effects and objects that the microphone body is worn conveniently and handy, can be applied to frames of various sizes and carried conveniently.

In comparison with the abovementioned prior art, the microphone that is worn on a pair of eyeglasses, according to the present invention, is further provided with following advantages:
1. As being installed on the temple at the side of the eyeglasses, the microphone body is worn conveniently and handy. In addition, the microphone body will not contact with the ear to cause uncomfortableness and can be applied to frames of various sizes and carried conveniently.
2. The microphone is highly sensitive to absorb sound sources easily and hence can be applied to all kinds of wireless microphone transmitters and all kinds of wired amplifiers.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A microphon comprising:
a microphone body, wherein, the microphone body is provided with a rod, an end of the rod is provided with a microphone, the other end of the rod is provided with a plug, and the rod is assembled with an electric wire through the plug and a socket; and
at least one suspender, wherein, an upper end of the suspender is used to be hung on a temple of an eyeglasses, and a lower end of the suspender is provided with a hook unit for hooking the rod of the microphone body.

2. The microphone according to claim 1, wherein the at least one suspender is two in number.
